(19) United States
(12) Patent Application Publication
(10) Pub. No.: US 2008/0162397 A1
(43) Pub. Date: Jul. 3, 2008

(54) Method for Analyzing Activities Over Information Networks

(76) Inventor: Ori Zaltzman, Netanya (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/619,210

(22) Filed: Jan. 3, 2007

(51) Int. Cl. G06N 5/02

(52) U.S. Cl. 706/48

(57) ABSTRACT

The present invention is a method for analyzing large volumes of network information for the purpose of identifying particular patterns of behavior in a plurality of connections. It enables identifying unique digital fingerprints of particular users, be it individuals, groups or organizations, and tracks their activities in large scale information networks such as corporate wide area networks or the public internet despite attempts on the part of the users to hide their identity. By recognizing unique identifiers and distinguishing patterns of behavior the method may differentiate between different users all using a single connection, or identify a single entity across multiple connections. The method may be applicable for tracking hostile entities inside an organizational network. Advertisers may uniquely and anonymously track the activities of users. The method may also be used to track and identify suspicious activities by law enforcement agencies via lawful interception of network data.

### BACKGROUND OF THE INVENTION

The present invention relates in general to systems and methods for analyzing and tracking activities of third parties over information networks. More particularly, the present invention relates to systems and methods for identifying and analyzing particular patterns of behavior of activities of third parties over information networks when the identity of the third parties is unknown and requires tracking.

When processing information originating from large-scale networks, such as business networks or the internet, conventional internet protocol (IP) address-based analysis methods, which assume each IP represents an entity, will fail to correctly associate the data with the on-going activities of a single user, be it a person, a small group or an organization. This is especially true when the activity of the user is spread over long time periods and extending over several different network connections. In the case of the internet, for instance, a user may connect to the network under several different identities, using different IP addresses each time. Additionally, the user may use different end-user devices (e.g. handheld mobile devices, laptops, IP phones, desktops etc.) and from different geographic locations. Also, in some cases, parties may actively attempt to disguise their identity for various reasons.

Common network analysis and tracking tools rely on physical network identifiers to locate and track network users. Examples include Media Access Control (MAC) addresses for in-network sniffers, phone ports for wiretapping or radius tickets for internet service provider (ISP) connections and IP addresses for internet connections. These methods might prove to be highly efficient for pinpointing network activities of a user in closed networks which use static-addressing methods. Yet, as network communication possibilities increase and with them the number of users striving for maximum anonymity, more of the activity of users is conducted through public and anonymous network portals, which do not disclose physical identifiers.

There is therefore a need for a means for an on-going tracking of the activity of users in large-scale communication networks. These means should not have to rely on information from sources which are external to the network itself but rather utilize hidden information in the network traffic, largely unknown to network users, to distinguish between different network users and overcome the difficulties posed by such networks.

### SUMMARY

The disclosed invention provides a solution to the above-mentioned needs. The preferred embodiments of the present invention provide a means for performing an on-going tracking of the activity of users in large-scale communication networks. The invention utilizes hidden information in the network traffic, largely unknown to network users, to distinguish between different network users and overcome the difficulties posed by such networks. The disclosed method analyzes large volumes of network information for the purpose of identifying particular patterns of behavior in a plurality of connections. The analysis performed by the method includes the following steps: identifying unique digital fingerprints of users, recognizing unique identifiers and distinguishing patterns of behavior.

The analysis also includes the step of identifying associations between different data segments to create a chronological stream of activities of network users called UniSessions. The UniSession uniquely identify a single user activity in a specific connection to the network. Additionally, the analysis includes the step of identifying associations between two or more UniSessions to create SuperSessions in accordance with predefined rules, unique identifiers and statistical probability calculations. A SuperSession represents the combined network activities of a specific network entity over time and its unique characteristics. The proposed method also includes means for analyzing, updating and finding new types of unique identifiers in a network environment.

### BRIEF DESCRIPTION OF THE DRAWINGS

These and further features and advantages of the invention will become more clearly understood in the light of the ensuing description of a preferred embodiment thereof, given by way of example, with reference to the accompanying drawings, wherein

FIG. 1 is a block diagram illustrating the flow of information in accordance with the preferred embodiments of the present invention;

FIG. 2 is a block diagram illustrating the logical compounds of Session, UniSession, SuperSession, and Group in accordance with the preferred embodiments of the present invention;

FIG. 3 is a block diagram illustrating the components of the Data Extractor in accordance with the preferred embodiment of the present invention;

FIG. 4 is a flowchart illustrating the data processing procedure performed by the Data Extractor in accordance with the preferred embodiment of the present invention;

FIG. 5 is a block diagram illustrating the data structure in the Database and in the Processor in accordance with the preferred embodiment of the present invention.

### DETAILED DESCRIPTION OF THE PREFERRED EMBODIMENTS

The present invention is a method for analyzing large volumes of network information for the purpose of identifying particular patterns of behavior in a plurality of connections. The method enables identifying unique digital fingerprints of particular users, and tracks their activities in large scale information networks such as corporate wide area networks or the public internet despite attempts on the part of the users to hide their identity. The term user may refer to an individual, a group or an organization. By recognizing unique identifiers and distinguishing patterns of behavior the method may differentiate between different users all using a single network connection, such as different users behind a proxy (all having the same external IP address), and across multiple connections (for example, different service providers, multiple routing options, via land or wireless, etc.), as is the case with frequently changing IP addresses or other common identifiers.

The proposed method may be applicable for automatically tracking entities inside an organizational network, such as financial institutions, in order to detect fraud, intrusion or other suspicious activities. Advertisers may use the proposed method to uniquely and anonymously track the activities of users and to analyze their subjects of interest in order to improve the effectiveness of advertising campaigns. The proposed system and method may also be used to track and identify suspicious activities of entities over private or public networks by law enforcement agencies via lawful interception of network data.

The proposed method performs the identification and tracking of entities in several phases. In the first phase, the large volumes of data received from information networks are processed, filtered and then associations are made between different data segments to create clusters of sessions related to the same network user—UniSessions. UniSessions are uniquely identified as belonging to the same user and represent the sum of the activities of this user during a single connection to the network. UniSessions are created by clustering data according to predefined rules and statistical probability calculations. Clustering Sessions into UniSessions may be based on time, data or behavioral consistency, such as: operating system type, application version, language, interest subjects, browsing behavior, etc. In the second phase, associations are made between the UniSession clusters to create SuperSessions. SuperSessions represent the sum of all the connections of a single network user to the information network across domains, geographical locations and different times. SuperSessions are created by clustering UniSessions according to unique user identifiers, such as digital fingerprints which are automatically extracted from each UniSession. Filtering, analysis and association criteria may be determined in a semi-automatic manner, allowing the users of the system to intervene in the decision-making process. Plugins are used for extracting metadata from binary or textual applications protocols in the network, and the off-line independent Unique Identifier Analyzer scans raw data to update and find new types of information which may be used as unique user digital fingerprints.

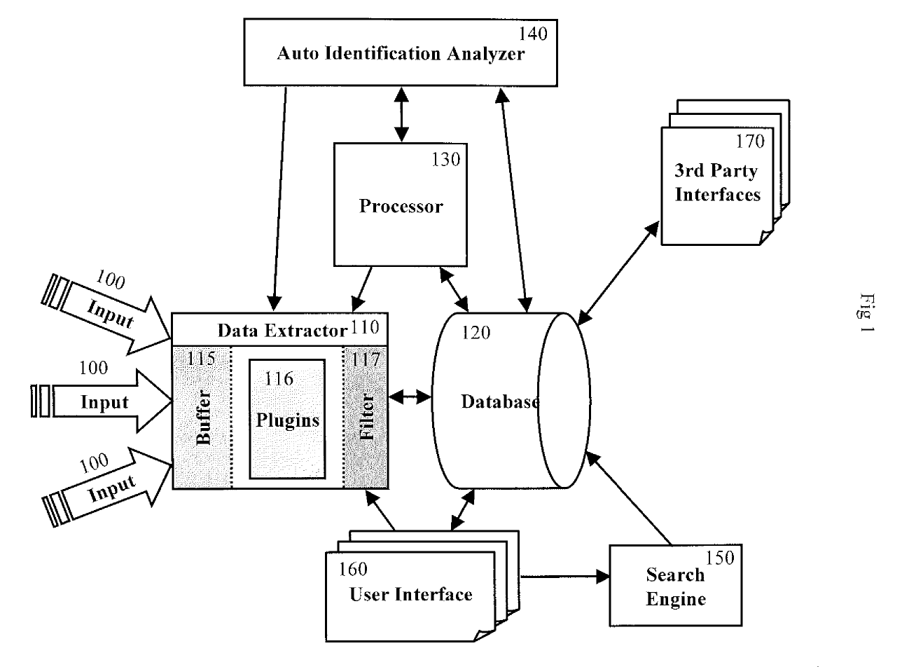

FIG. 1 is an illustrative block diagram showing the principal components of the present invention and the flow of information between them according to the preferred embodiment. The data input 100 streams into the Data Extractor 110 where initial processing and filtering of the flow of data is performed. The main purpose of the Data Extractor 110 is to process and filter the large volumes of data, using Filter 117. The filtered data is then stored in Database 120. Processor 130 performs in-depth analysis of the data in Database 120, and the processed data is stored back in Database 120. Based on its analysis, Processor 130 also updates processing and filtering parameters in the Data Extractor 110. The processed data stored in Database 120 is then made accessible to the users of the system through User Interface 160, and both processed and unprocessed raw data may be retrieved by the users using Search Engine 150. Authorized third party systems may be integrated into the system and may gain access to the data in the Database 120 through Third Party Interface 170. The system may retrieve and use data from external sources through Third Party Interface 170. Search Engine 150 allows the users of the system to search the raw data and metadata stored in Database 120. In Addition, Search Engine 150 may also regularly perform predefined queries and notify users when new data of interest is retrieved by these queries. The system may employ queues in order to manage query results for different system users and enable the users to manage of the results.

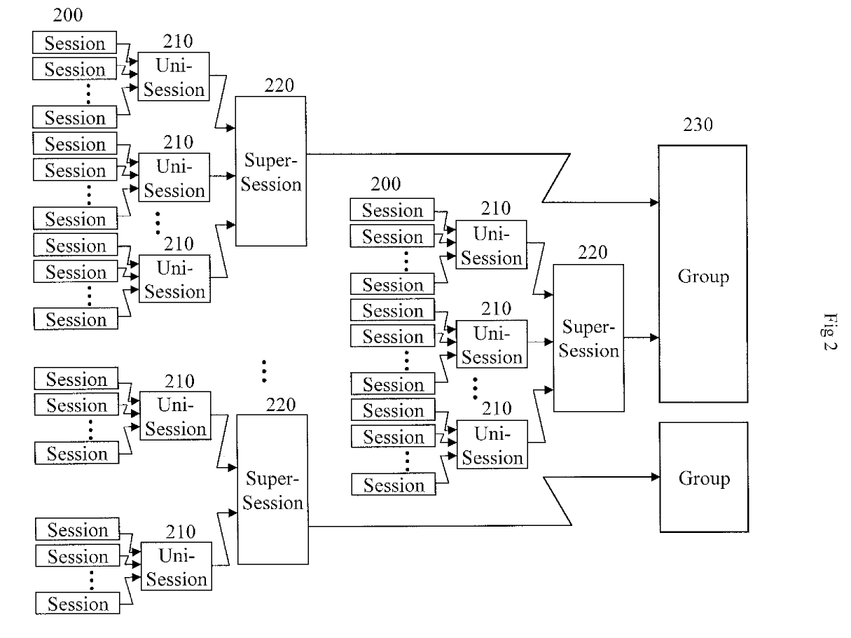

FIG. 2 is a block diagram illustrating the logical structure according to which the raw data collected in Database 120 is processed by Processor 130. In its initial state data is collected in Sessions 200. A Session 200 is a single continuous connection with uniform characteristics, such as a specific file download, web page request, sending an email message and the like. Each UniSession 210 is a combination of several Sessions 200 which probabilistically share common characteristics and may therefore be identified as belonging to a single communication network user. Each UniSession 210 is comprised of at least one Session 200. The process of associating between Sessions 200 to create a UniSession 210 is fully automatic, but its criteria and parameters may be based on statistical probability calculations or manually configured. This process may be configured manually via User Interface 160. The statistical probability associations are calculated according to characteristics shared by Sessions 200 which have a high probability of belonging to a single continuous network user. For each Session 200 that was associated with a UniSession 210 an association probability figure may be stored in Database 120. The association probability may decline as the UniSession time length grows and no other unique identifiers were found.

A combination of several UniSessions 210 may comprise a single SuperSession 220. The association between UniSessions 210 is done according to distinct common characteristics of a user as extracted from the UniSessions of the user and may include sharing a unique identifier or a well defined digital fingerprint pattern. A unique identifier used to create a digital fingerprint may be an email address, login parameters for a specific network application (username and password), user cookies, software subscription identifiers or any other binary patterns that network applications or devices use to identify specific returning users. Each SuperSession 220 is comprised of at least one UniSession 210. The process of associating several UniSessions 210 into a single SuperSession 220 is automatic, but may be configured manually via User Interface 160. Groups 230 are tags used to denote common characteristics of SuperSessions, for example a group may link all the users or SuperSessions who for example have common interests, belong to the same computer network, share a single internet connection or use a common application.

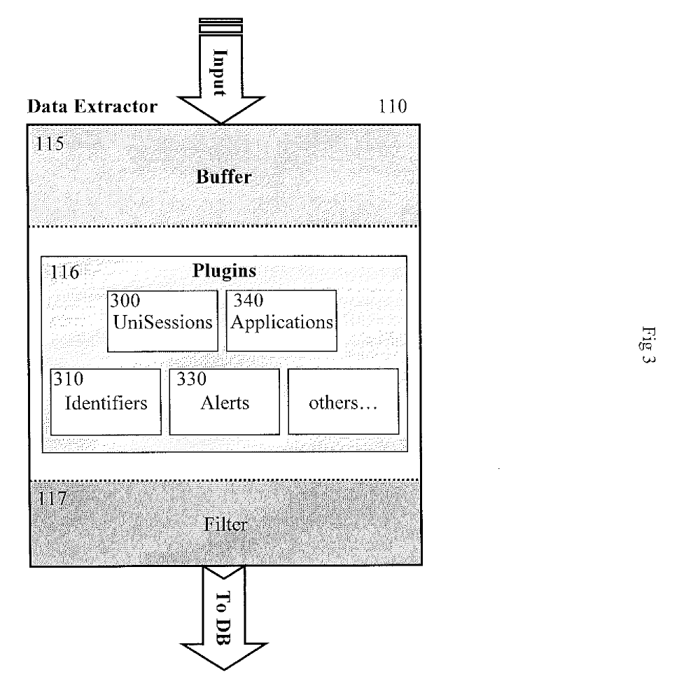

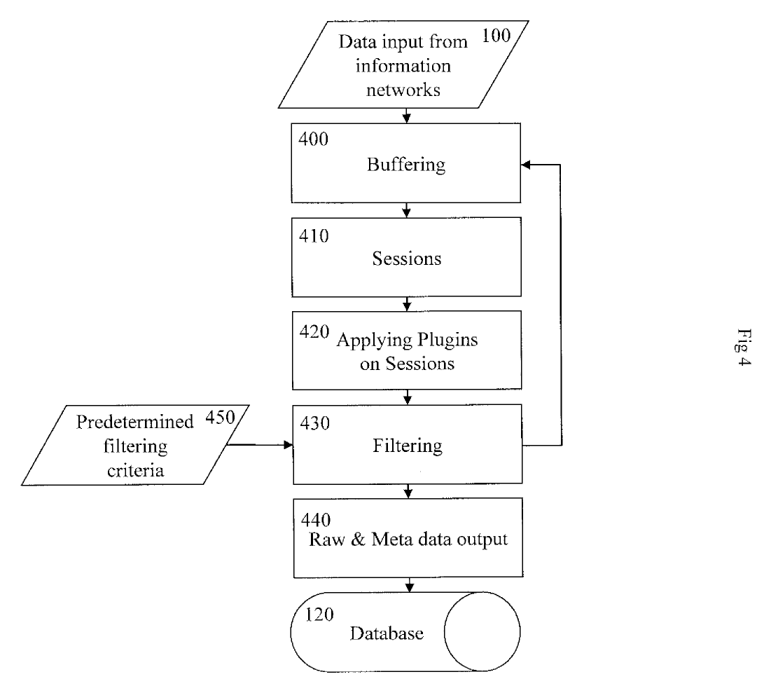

FIG. 3 is a block diagram illustrating the structure of the Data Extractor 11.0 and FIG. 4 is a flowchart illustrating its manner of operation. The Data Extractor 110, which receives the flow of data from the networks feeds, comprises three major parts: Buffer 115, Plugins 116 and Filter 117. Buffer 115 stores all inputs for a predetermined time period (step 400). The main purpose of Buffer 115 is to allow Data Extractor 110 to retract and draw data which was initially filtered and disregarded if the system finds it relevant later on. The input data is processed, assembled and differentiated into Sessions (step 410) and then all data is processed by Plugins 116 (step 420). Plugins 116 includes several mini-processors which can each perform domain specific analysis of the examined data according to preprogrammed patterns as well as data patterns already collected by the system. The operation of the different Plugins 116 is to generate metadata from network raw data and the data of different applications to be used as part of the UniSession and SuperSession creation process and to feed Filter 117 with relevant information regarding the inputted data. For instance, UniSession Plugin 300 includes unique identifiers which can be used to link multiple user sessions; Application Plugin 340 extracts metadata and identifiers from common binary software application data streams or files such as messaging protocols, email, word processing applications and compression utilities; Identifiers Plugin 310 includes a list of all the types of unique identifiers which were found by the Auto Identification Analyzer 140 and extracts them accordingly. Alerts Plugin 330 includes particular criteria which, when met, an alerting message is sent to one or more end-users of the system via email, short messaging service (SMS), pager or other means. Such criteria may include a particular combination of details or any specific unique identifier. Any additional Plugins may also be added and used by the system. In addition to collecting data from the Plugins 116, Filter 117 receives data from the User Interface 160 regarding predefined filtering criteria (step 450). The predefined filtering criteria are determined by the managers of the system according to their needs, to the storage capacity of the system and to information collected by external means. All filtered data is then sent to the Database 120 for storage (step 440). Original raw data may also be stored in Database 120 for later use according to predefined criteria. Some high-level filtering may be performed before Buffer 115.

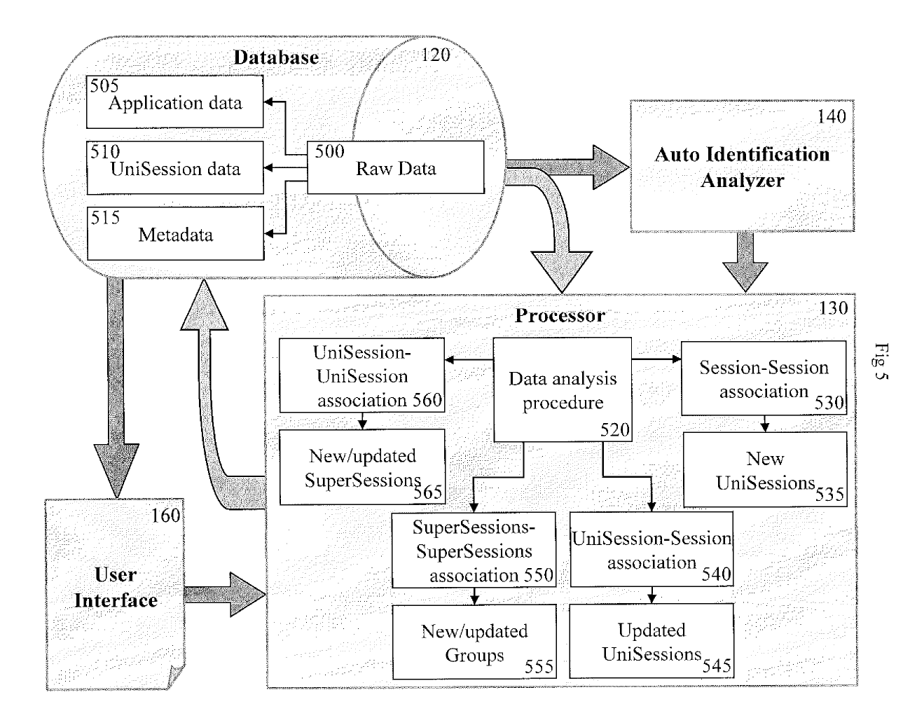

FIG. 5 is a block diagram illustrating the logical data structure of Database 120 and Processor 130. Raw Data 500, which may be stored in Database 120 as it is received from Data Extractor 110 (see FIG. 1), is processed by Processor 130. Data Analyzing Procedure 520 performs the association between data segments and extracts categorizing data. According to unique identifier input from the Auto Identification Analyzer 140, Processor 130 associates between sessions 530 to create new UniSessions 535, and by associating an unassociated Session and a Session which is already associated to a UniSession 540, Processor 130 updates existing UniSessions 545. Based on statistical calculations of probability combined with data received from the User Interface 160 and according to unique identifiers extracted from each UniSession, Processor 130 associates between UniSessions 560 to create new SuperSessions and update existing ones 565, and associates between SuperSessions 550 to create Groups 555. Analyzed data as well as its associations are stored in Database 120 along side raw data. All information about associations between data segments is stored in the Metadata tables 515 and information regarding identifying parameters and information about known UniSessions is stored in the UniSession data tables 510. Additional output from Plugins 116 is stored in the Application data tables 505. Other tables may be stored in Database 120 for additional Plugins 116.

The Auto Identification Analyzer 140 is an independent processor, which performs periodic offline analysis of the data in Database 120 for the purpose of finding and updating new types of unique identifiers which may be used by the processor 130 to unambiguously identify a user for the purpose of creating UniSessions and SuperSessions. Such identifiers may include unique codes sent over the network by end-user devices, operating systems, applications, servers, communication protocols, web sites or other software. Once such identifiers are found by Auto Identification Analyzer 140, Processor 130 is updated and the type of data singled out by the Auto Identification Analyzer 140 is used to associate between different Sessions and UniSessions to create SuperSessions.

The method for updating or finding new unique identifiers consists of searching for a textual or binary pattern which reappears in two or more different UniSessions inside a single SuperSession. The pattern may be a cookie in a web session, customer number, device identifier, random identifier or any field in a communication protocol which uniquely identifies the end-user or device over a minimum period of time. The method should then verify that no two different SuperSessions share the same pattern to prove that it uniquely categorizes a network user or device. If a unique pattern is found in the system data and verified successfully on multiple already known users, process 130 updates the parameters of Identifiers Plugin 310. The output of the Auto Identification Analyzer 140 may be the positions of the unique identifier in a specific protocol, name of cookie, name of field, regular expression or other combination of rules in order to locate the unique identifier.

Through User Interface 160, which is illustrated in FIG. 1, the users of the system may examine and control the system analysis methods of the incoming data. Users may view the details and content of Sessions 200, UniSessions 210, SuperSessions 220 and of Groups 230 as retrieved by the system. The users of the system may also review and edit the rules according to which the data is analyzed. Users may classify the retrieved data into categories and view, edit and create connections and relationships between entities. Through the user interface 160 users may also define particular events as critical and ones which would draw special attention to a specific entity or activity.

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for analyzing large volumes of network information for the purpose of identifying particular patterns of behavior in a plurality of connections, wherein the analysis include the following steps:
associating between different data segments for creating clusters of related Sessions (“UniSessions”), wherein each said UniSession represents activities of a single entity during a single connection to the network;
identifying associations between at least two different UniSessions to create SuperSessions in accordance with predefined rules and unique identifiers

2. The method of claim 1 wherein the clustering is based on at least one of the following: time, data, behavior consistency relating to technical software properties and behavior consistency relating to context and user interactions during a surfing session.

3. The method of claim 1 further comprising the step of:
identifying unique digital fingerprints of users extracted from UniSessions by distinguishing behavior patterns of a user in a UniSession.

4. The method of claim 1 wherein a human operator intervenes in the analysis process.

5. The method of claim 1 further comprising the step of extracting metadata from binary applications in the network.

6. The method of claim 1 further comprising the step of analyzing metadata and raw-data for updating and identifying new types of unique identifiers in a network environment.

7. The method of claim 1 further comprising the steps of:
recording all accumulated network information over predefined period in a temporary buffer;
retrieving buffered data in accordance with created clusters and unique identifiers.

8. The method of claim 1 wherein the creation of SuperSessions is further based on statistical probability calculations.

9. The method of claim 1 further comprising the step of clustering SuperSessions to create groups in accordance with common characteristics of the SuperSessions.

10. The method of claim 1 further comprising the step of sending an alert message according to predefined criteria relating to particular combination of details or any specific unique identifier

11. The method of claim 1 further comprising the step of performing domain specific analysis of the examined data according to predefined patterns and generating metadata from network raw data and the data of different applications to be used as part of the UniSession and SuperSession creation process, wherein the said analysis and metadata generation is preformed by a plugin.

12. A system for analyzing large volumes of network information for the purpose of identifying particular patterns of behavior in a plurality of connections, wherein the system comprises:
a data extractor for processing and filtering of the flow of data;
a main processor for performing in-depth analysis of the filtered data stored in a database unit, said processor comprised of the following modules:
i. a first analysis module for associating between different data segments for creating clusters of UniSessions, said UniSession represents activities of a single user(entity) during a single connection to the network;
ii. a second analysis module for identifying associations between the clusters of UniSessions to create SuperSessions in accordance with predefined rules and unique identifiers.

13. The system of claim 12 wherein the analysis further includes identifying unique digital fingerprints of users by distinguishing patterns of user behavior.

14. The system of claim 12 wherein the data extractor includes plugins, wherein each plugin includes at least one mini-processor for performing domain specific analysis of the examined data according to predefined patterns, generating metadata from network raw data and the data of different applications to be used as part of the UniSession and SuperSession creation process.

15. The system of claim 12 further comprising an Auto Identification Analyzer processor, which performs periodic offline analysis of the metadata for finding and updating new types of unique identifiers which may be used by the main processor to unambiguously identify a user for the purpose of creating UniSessions and SuperSessions.

16. The system of claim 12 wherein said association analysis further includes a verification module of a unique user by searching and identifying a textual or binary pattern which reappears in two or more different UniSessions inside a single SuperSession.

17. The system of claim 12 wherein the creation of SuperSessions is further based on statistical probability calculations.
